(19) United States
(12) Patent Application Publication
(10) Pub. No.: US 2003/0052599 A1
(43) Pub. Date: Mar. 20, 2003

(54) White light LED illumination apparatus

(76) Inventor: Hsueh-Feng Sun, Taoyuan (TW)

Correspondence Address: SEYFARTH SHAW, Suite 4200, 55 East Monroe Street, Chicago, IL, 60603-5803, US

(21) Appl. No.: 10/242,033

(22) Filed: Sep. 12, 2002

(30) Foreign Application Priority Data
Sep. 14, 2001 (TW) 090122888

(51) Int. Cl. H05B 33/00

(52) U.S. Cl. 313/512; 313/509

(57) ABSTRACT

The present invention reveals a white light LED illumination apparatus that comprises a printed circuit board, a plurality of single color LEDs, at least one electricity terminal and a transparent casing. The plurality of single color LEDs are set on the printed circuit board. At least one electricity terminal is connected to the printed circuit board and a power source. The transparent casing with a fluorescent material layer, connected to at least one electricity terminal, determines a closed room to accommodate the printed circuit board. The fluorescent material layer can be activated by the light generated from the plurality of single color LEDs to generate light by mixing with the light from the single color LEDs to generate white light.

### BACKGROUND OF THE INVENTION

(A) Field of the Invention

The present invention relates to a design of a luminous device and the application thereof, more specifically, to a white light LED (Light Emitting Diode) illumination apparatus.

(B) Description of Related Art

Nowadays, a conventional fluorescent lamp flashes 120 times per second. The flash frequency of the accompanying ultraviolet light is too fast to be aware by human naked eyes, and thus the eyes are injured unaware. Moreover, the high power consumption of the conventional fluorescent lamp cannot meet the environmental criteria.

An LED is an optoelectronic device, capable of emitting luminescence, and includes two electrode terminals and a semiconductor chip. As voltage is applied between the electrode terminals, the induced tiny current is able to light the LED. Because the LED is not lighted by heat or discharge, the lifetime of an LED device is more than 100,000 hours. Furthermore, the merits of the LED, including no idle time, quick response (approximate 10⁻⁹ second), small volume, high reliability, capability of being fabricated into array element, high photoelectric transfer efficiency, minor power consumption (approximate 10% of an incandescent lamp) and excellent shock-resistance, quite meet the trends of e-generation products, for example, superior portability and capability. Hence, a white light LED will be the best substitute of present white light luminous source.

An earlier white LED is based on the chromatics in mixing adequate ratio of the lights of blue light LED, red light LED and green light LED to generate white light. FIG. 1 illustrates a known white light LED apparatus, where there are two red light LEDs, two green light LEDs and a blue light LED within every pixel of the white light LED. The white light LED is costly due to the use of large amounts of single color LEDs. Each kind of single color LEDs has to be able to generate a light of specific intensity followed by mixing with the other kinds of single color LEDs to generate the white light, so the applied voltage of each kind of single color LEDs is different, and thus the design of the driving circuit becomes more complicated. Moreover, because the known white light generated by the white light LED is mixed with three kinds of single color LEDs, if one kind of single color LEDs is degraded, the light mixture will be influenced, and thus pure white light is hard to be derived.

To overcome the above mentioned LEDs, Japan Nichia Chemical Industries, Ltd has further developed a white light LED apparatus, which generates white light not via the mixture of the lights of red light LED, green light LED and blue light LED. FIG. 2 illustrates the white light LED apparatus developed by Nichia Chemical Industries, Ltd. The white light apparatus includes a conductive grain cup 15a, a blue light LED grain 12 placed in the grain cup 15a, a metal electrode 15b, gold wires 13 in connection between blue light LED grain 12 and the metal electrode 15b or the grain cup 15a, a fluorescent material 14 covered on the blue light LED grain 12, and a casing 16. The white light LED apparatus employs the mixture of the blue light emitted by the blue light LED grain 12 and the yellow light generated from the fluorescent material 14 activated by the blue light to produce the white light. In such case, the cost of the white light LED can be decreased, and the design of the driving circuit is greatly simplified. However, the heat produced during the chip operation induces the average lifetime of the fluorescent material 14 to be only between 5,000 to 10,000 hours, which is much less than that of the LED grain of approximately 100,000 hours. Therefore, the lifetime of the entire apparatus is extremely limited. In addition, non-uniform color temperature and luminous dead space phenomenon may frequently occur in the apparatus shown in FIG. 2.

### SUMMARY OF THE INVENTIION

The first object of the present invention is to provide a white light LED illumination apparatus, which can simplify the process by decreasing the times of packaging the white light LED.

The second object of the present invention is to provide a white light LED illumination apparatus of uniform color temperature without luminous dead space.

The third object of the present invention is to provide a white light LED illumination apparatus, which is capable of plug-and-play, and thus need not replace present lamp.

The fourth object of the present invention is to provide a white light LED illumination, which can extend the lifetime of the illumination apparatus, reduce the replacement times and thus lower the cost of the illumination apparatus.

The present invention reveals a white light LED apparatus achieving the above objects, which comprises a printed circuit board, a plurality of single color LEDs, at least one electricity terminal and a transparent casing. The plurality of single color LEDs are placed on the printed circuit board. The electricity terminal is connected to the printed circuit board and to a power source to supply power to the entire apparatus. The transparent casing and the electricity terminal confines a closed room to accommodate the printed circuit board, in which a layer of fluorescent material is covered on the inner surface of the transparent casing.

The present invention mainly employs the light emitted by the single color LEDs to activate the fluorescent material of specific absorption wavelength covered on the inner surface of the transparent casing. The activated fluorescent material will emit a light of another wavelength, and the light of the single color LEDs and the light generated from the activated fluorescent material can be mixed to generate white color by means of adequately adjusting the LED luminance and the concentration of the fluorescent material.

### BRIEF DESCRIPTION OF THE DRAWINGS

FIG. 1 illustrates a known white light LED apparatus;

FIG. 2 illustrates another known white light LED apparatus;

FIG. 3 illustrates the white light LED apparatus of the first embodiment in accordance with the present invention;

FIG. 4 is the top view of the white light LED apparatus of the first embodiment in accordance with the present invention;

FIG. 5 is the amplification of the part of the white light LED apparatus shown in FIG. 3.

FIG. 6 illustrates the white light LED apparatus of the second embodiment in accordance with the present invention; and

FIG. 7 is the cross-sectional view of the second embodiment in accordance with the present invention.

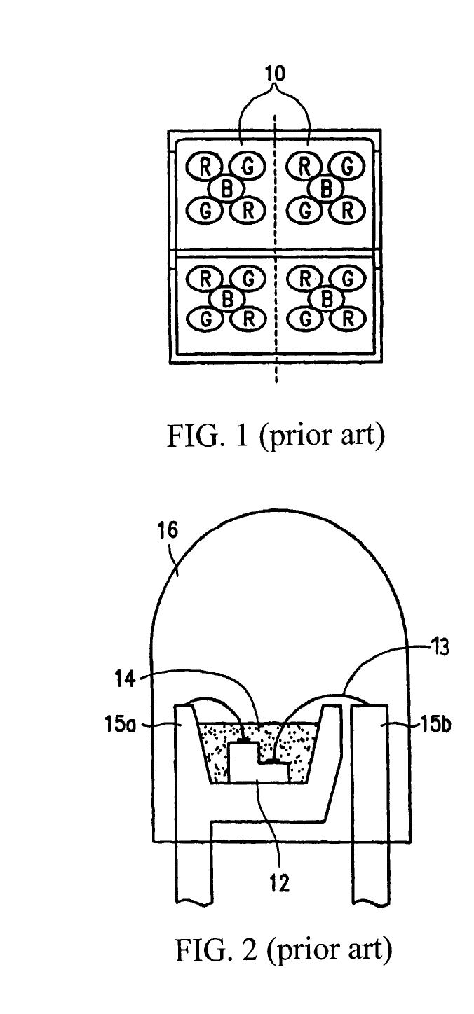

### DETAILED DESCRIPTION OF THE INVENTION

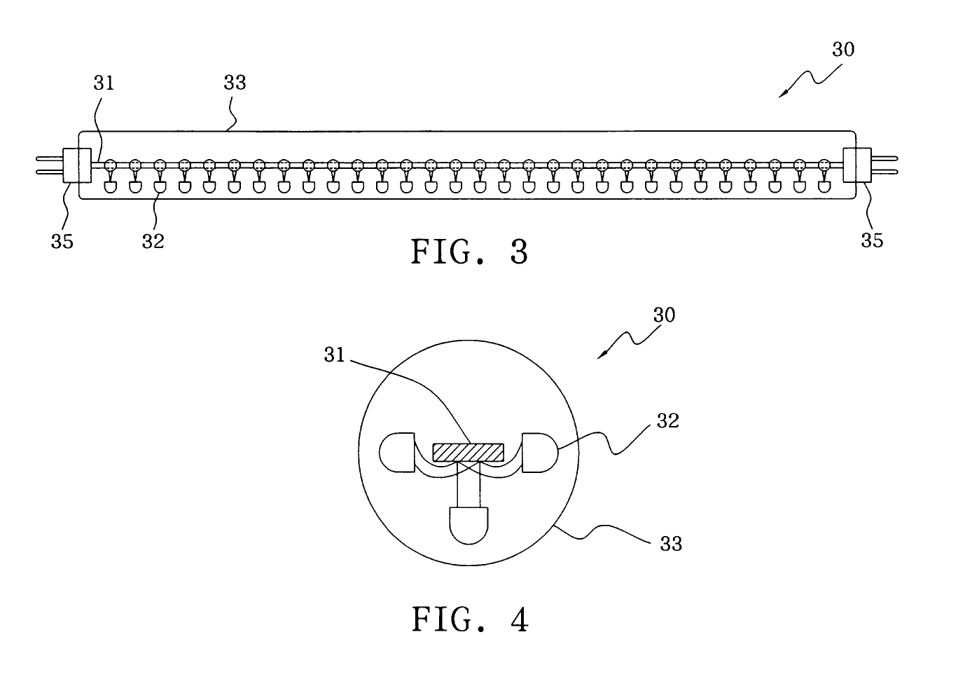

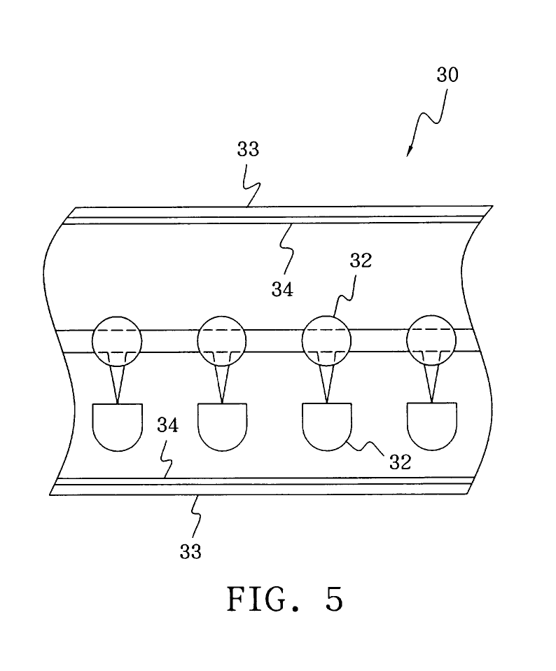

FIG. 3 illustrates the white light LED apparatus 30 of the first embodiment in accordance with the present invention. The top view thereof is shown in FIG. 4, which is in the form of a common fluorescent lamp, in which single color LEDs 32 are set on a strip-like printed circuit board 31 as luminous sources. The single color LEDs 32 of the first embodiment uses blue light LEDs, and can be replaced with UV LEDs. The number and the disposition of the blue light LEDs are dependent on the required luminance. The single color LEDs are plugged into the surface of the printed circuit board 31 facing towards the ground, i.e. the light will be emitted downward, so power can be saved by avoiding the power consumption of the needless ceiling lighting. To obtain uniform color temperature and avoid luminous dead space, the single color LEDs 32 is disposed as an arc. The white light LED apparatus 30 further comprises a transparent casing, for example, a lamp 33 which can be made of glass, Polymethylmethacrylat (PMMA) or other transparent solid material. The inner surface of the lamp 33 is covered by a layer of fluorescent material 34 as shown in FIG. 5. The absorption wavelength of fluorescent material 34 has to match the single color LEDs 32, for example, because of the use of blue light LED in the embodiment; Yttrium Aluminum Garnet (YAG) is selected as the fluorescent material 34. When voltage is applied to the blue light LEDs, the blue light LEDs will emit blue light of 470 nm wavelength. The fluorescent material 34 will be activated to emit yellow light of wide spectrum, of which the peak is at 580 nm, and the half height-width is 160 nm. By means of adjusting the concentration of the fluorescent material 34 and the intensity of the single color LED 32 itself, white light or other light can be obtained after the lights mixed. Moreover, two lamp plugs 35, served as electricity terminals, are connected to the two ends of the lamps 33 respectively as well as to the printed circuit board 31, which is an attempt to supply external power to the single color LEDs 32 on the printed circuit board 31 as the lamps 33 are put in the lamp base (not shown).

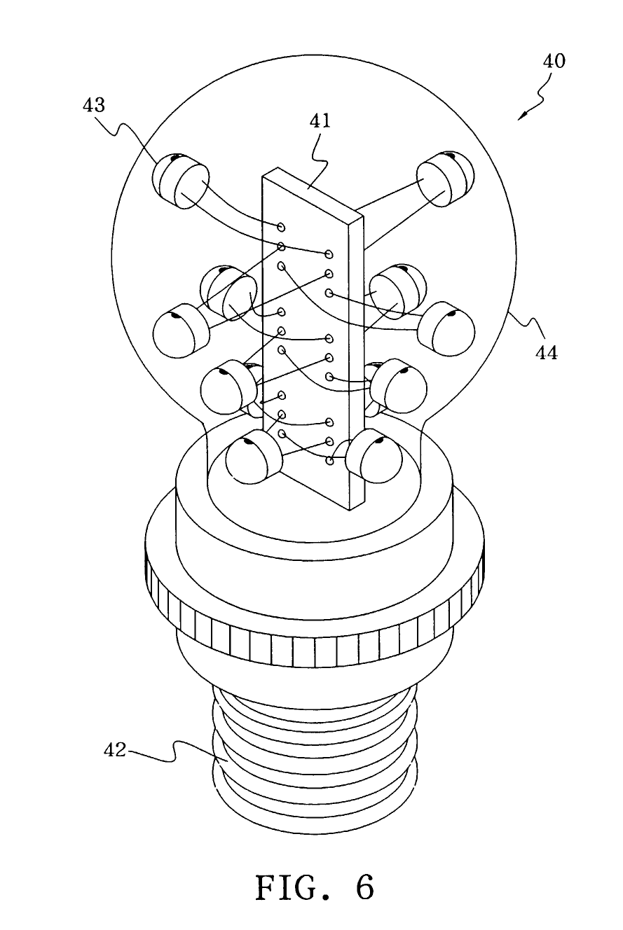

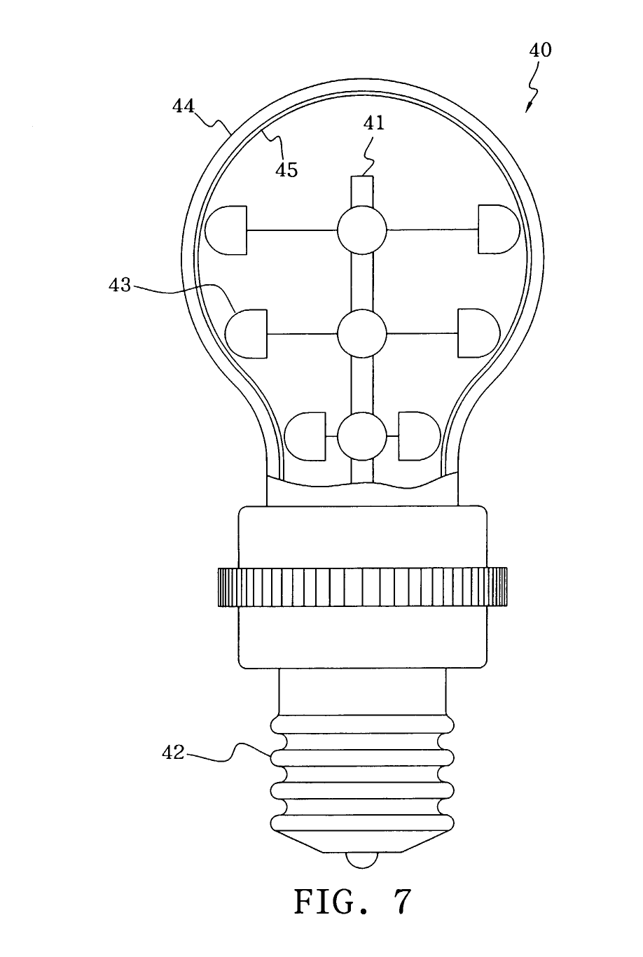

The second embodiment reveals a bulb type white light LED illumination apparatus 40 shown in FIG. 6 and FIG. 7. The apparatus 40 comprises a printed circuit board 41 whose one end is connected to a lamp base 42, a plurality of single color LEDs 43 set on the printed circuit board 41, and a lamp casing 44 having a layer of fluorescent material 45 covered on the inner surface and an opening that joints the lamp base 42. The lamp base 42 may be electrically connected to an external power source to supply power to the single color LEDs 43. The printed circuit board 41 is within the closed room formed by the lamp casing 44 and the lamp base 42. The lighting mechanism of the second embodiment is the same as that of the first embodiment, where they all employ the light emitted from the single color LEDs 43 to activate the fluorescent material 45 covered on the inner surface of the lamp casing 44, emitting another color light, which can be mixed with the light of the single color LEDs 43 to generate white light. Because the single color LEDs 43 are plugged in a way to obtain same distance between each luminous source and casing, uniform temperature color can be achieved.

Because the fluorescent material is separated from the single color LEDs and is not covered directly on the surface of the single color LEDs in accordance with the present invention, it is difficult for the heat generated by the single color LEDs to influence the fluencent material, i.e. the degradation of the fluorescent material is much slower than that of other common white light LED, and thus longer lifetime of the white light LED can be derived. The light direction can be controlled by adjusting the disposition of the single color LEDs on the printed circuit board, so the light can be concentrated on the area needed to be lighted whereby the cost of the entire apparatus as well as energy consumption can be decreased. Moreover, the non-uniform luminous source or luminous dead space problems, occurring in conventional white light LED apparatus, due to the way of plugging the single color LEDs can be avoided in accordance with the present invention, and thus an illumination apparatus with uniform color temperature can be derived. Moreover, the printed circuit board can use a multi-layer board or a soft board, depending upon the requirement of the white light LED illumination apparatus. Besides being covered on the inner surface of the casing the fluorescent material can be covered on the outer surface of the casing, or mixed with raw casing material and then fabricated by mold-injection to produce the casing, i.e. the fluorescent material is substantially mixed in the casing. Table 1 shows the comparison of the conventional white light LED and the white light LED of the present invention. Obviously, the performance of the white light LED of the present invention is superior to that of the conventional lamp and conventional white light LED.

TABLE 1

| | | | White light LED |
|---|---|---|---|
| | Conventional | Conventional | of the present |
| | lamp | white light LED | invention |
| Color | uniform | Non-uniform | uniform |
| temperature | | | |
| Power | Higher | Lower | Lower |
| consumption | | | |
| Light | Uncontrollable | Controllable | Controllable |
| direction | | | |
| Cost | Low | High | Low |
| Lifetime | 1,000 to 20,000 hr | 5,000 to | 100,000 hr |
| | | 10,000 hr | |
| Utility | Suitable for direct | Not suitable to | Suitable for direct |
| | use on a common | direct use on a | use on a common |
| | lamp | common lamp | lamp |

The above-described embodiments of the present invention are intended to be illustrative only. Numerous alternative embodiments may be devised by those skilled in the art without departing from the scope of the following claims.

What is claimed is:

1. A white light LED illumination apparatus, comprising:
a printed circuit board;
a plurality of single color LEDs placed on the printed circuit board;
at least one electricity terminal connected to the printed circuit board; and
a transparent casing connected to at least one electricity terminal, the transparent casing enclosing the printed circuit board and having a fluorescent material layer.

2. The white light LED illumination apparatus in accordance with claim 1, wherein the printed circuit board is a multi-layer board or a soft board.

3. The white light LED illumination apparatus in accordance with claim 1, wherein the single color LEDs are one kind of blue light LED and ultraviolet light LED.

4. The white light LED illumination apparatus in accordance with claim 1, wherein an absorption wavelength of the fluorescent material can be activated by the light of the single color LEDs.

5. The white light LED illumination apparatus in accordance with claim 1, wherein the fluorescent material layer is formed on a surface of the transparent casing or mixed in the transparent casing.

6. A white light LED illumination apparatus, comprising:
a printed circuit board;
a plurality of single color LEDs placed on the printed circuit board;
two lamp plugs connected to the printed circuit board; and
a transparent lamp including a fluorescent material layer, wherein two ends of the transparent lamp are connected to the two lamp plugs.

7. The white light LED illumination apparatus in accordance with claim 6, wherein the transparent lamp is in a ring shape or a bar shape.

8. The white light LED illumination apparatus in accordance with claim 6, wherein the single color LEDs are one kind of blue light LED and ultraviolet light LED.

9. The white light LED illumination apparatus in accordance with claim 6, wherein an absorption wavelength of the fluorescent material can be activated by the light of the single color LEDs.

10. The white light LED illumination apparatus in accordance with claim 6, wherein the fluorescent material layer is formed on a surface of the transparent casing or mixed in the transparent casing.

11. A white light LED illumination apparatus, comprising:
a printed circuit board;
a plurality of single light LEDs placed on the printed circuit board;
a lamp base, one end of the lamp base connected to the printed circuit board; and
a lamp casing including a fluorescent material layer and an opening connected to the lamp base.

12. The white light LED illumination apparatus in accordance with claim 11, wherein the single light LEDs are one kind of blue light LED and ultraviolet LED.

13. The white light LED illumination apparatus in accordance with claim 11, wherein an absorption wavelength of the fluorescent material can be activated by the light of single light LEDs.

14. The white light LED illumination apparatus in accordance with claim 11, wherein the fluorescent material layer is formed on a surface of the transparent casing or mixed in the transparent casing.
